(19) United States
(12) Patent Application Publication
(10) Pub. No.: US 2016/0049789 A1
(43) Pub. Date: Feb. 18, 2016

(54) ENERGY MANAGEMENT SYSTEM

(71) Applicant: LIRICCO TECHNOLOGIES LTD., Hong Kong (CN)

(72) Inventors: Mei NG, Toronto (CA); Ka Chun LI, Hong Kong (CN)

(21) Appl. No.: 14/784,018

(22) PCT Filed: Apr. 11, 2014
(86) PCT No.: PCT/CN2014/075197

§ 371 Date: Oct. 12, 2015

Related U.S. Application Data
(60) Provisional application No. 61/810,925, filed on Apr. 11, 2013.

(51) Int. Cl. H02J 3/14; G05B 19/042

(52) U.S. Cl. CPC H02J 3/14; G05B 19/042; G05B 2219/2639

(57) ABSTRACT

There is provided an energy management system comprising a server, and one or more network devices communicatively connectable to the server. At least one of the network devices is a power measurement device for connection with an electrical device to collect real-time power data from the electrical device. The server compares the real-time power data with a corresponding power profile of the electrical device to determine whether preset trigger criteria has been met, and initiates a predetermined action when the preset trigger criteria has been met. An associated method of managing energy is also provided.

### TECHNICAL FIELD

The present invention relates to energy management systems and methods of operating such systems, and in particular, energy management systems than can be accessed and operated remotely.

### BACKGROUND ART

Current energy management systems involve the measurement and control of electrical devices and require cumbersome user inputs to enable the systems to eliminate energy waste. These systems usually provide the power parameters of electrical devices and energy usage information such as standby power, operating power, monthly energy consumption to a user and allow the user to control the electrical devices with varying degrees of sophistication, such as on/off state or dimming level in the case of lighting. However, users have to monitor the state of the electrical devices constantly and they also need to issue control commands based on the inputs. The complexity in current energy management systems have not been well received as they are typically inconvenient to use for the user.

It is an object of the present invention to overcome or ameliorate at least one of the disadvantages of the prior art, or to provide a useful alternative.

### DISCLOSURE OF INVENTION

The present invention provides, in a first aspect, an energy management system comprising:

a server; and

one or more network devices communicatively connectable to the server, at least one of the network devices being a power measurement device for connection with an electrical device to collect real-time power data from the electrical device;

the server comparing the real-time power data with a corresponding power profile of the electrical device to determine whether preset trigger criteria has been met, and initiating a predetermined action when the preset trigger criteria has been met.

In a second aspect, the present invention provides a method of managing energy with an energy management system comprising:

a server; and

one or more network devices communicatively connectable to the server, at least one of the network devices being a power measurement device for connection with an electrical device to collect real-time power data from the electrical device;

the method comprising:

comparing the real-time power data with a corresponding power profile of the electrical device to determine whether preset trigger criteria has been met; and

initiating a predetermined action when the preset trigger criteria has been met.

The present invention also provides, in a third aspect, a non-transitory computer-readable storage medium with an executable program stored thereon, wherein the program instructs a server to perform the method described above.

Further features of various embodiments of the present invention are defined in the appended claims. It will be appreciated that features may be combined in various combinations in various embodiments of the present invention.

Throughout this specification, including the claims, the words ‘comprise’, ‘comprising’, and other like terms are to be construed in an inclusive sense, that is, in the sense of ‘including, but not limited to’, and not in an exclusive or exhaustive sense, unless explicitly stated otherwise or the context clearly requires otherwise.

### BRIEF DESCRIPTION OF DRAWINGS

### Description of Drawings

Preferred embodiments in accordance with the best mode of the present invention will now be described, by way of example only, with reference to the accompanying figures, in which:

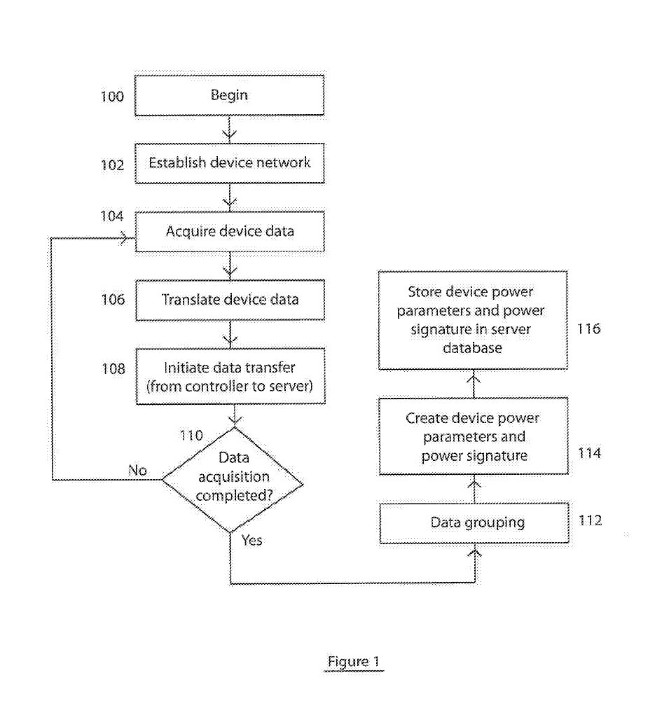

FIG. 1 is a flow diagram of a method of detecting and analyzing the power profile of an electrical device in accordance with an embodiment of an aspect of the present invention;

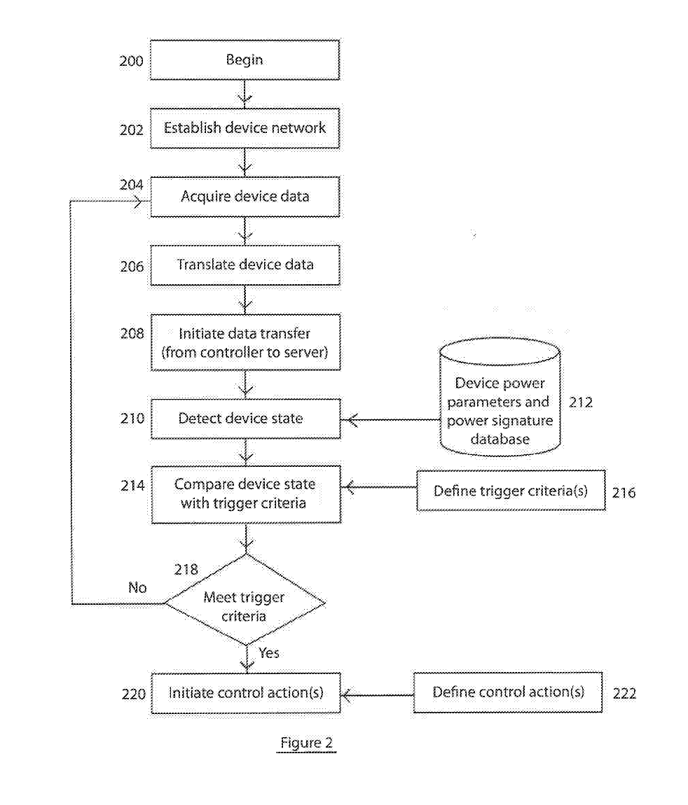

FIG. 2 is a flow diagram of a method of managing energy in accordance with an embodiment of an aspect of the present invention;

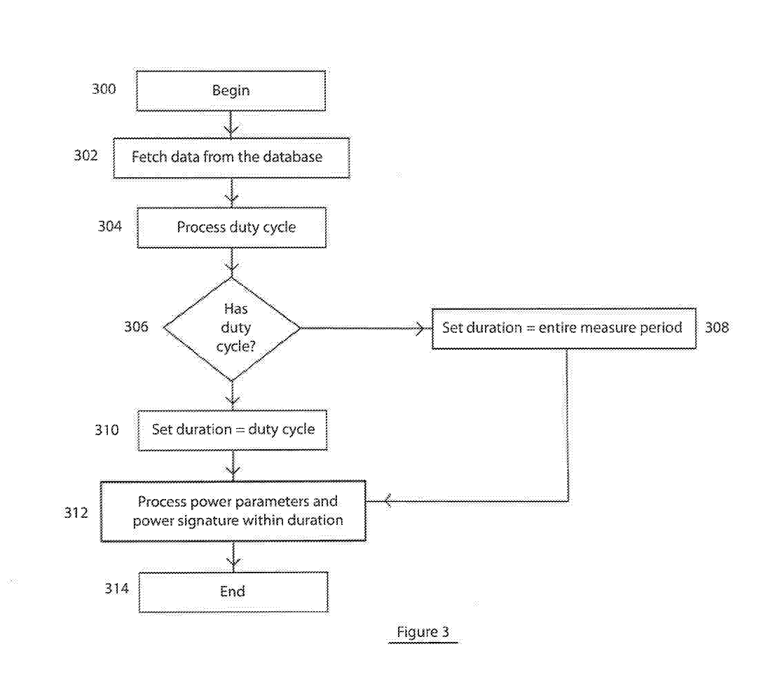

FIG. 3 is a flow diagram of a method of processing a power profile in accordance with an embodiment of an aspect of the present invention;

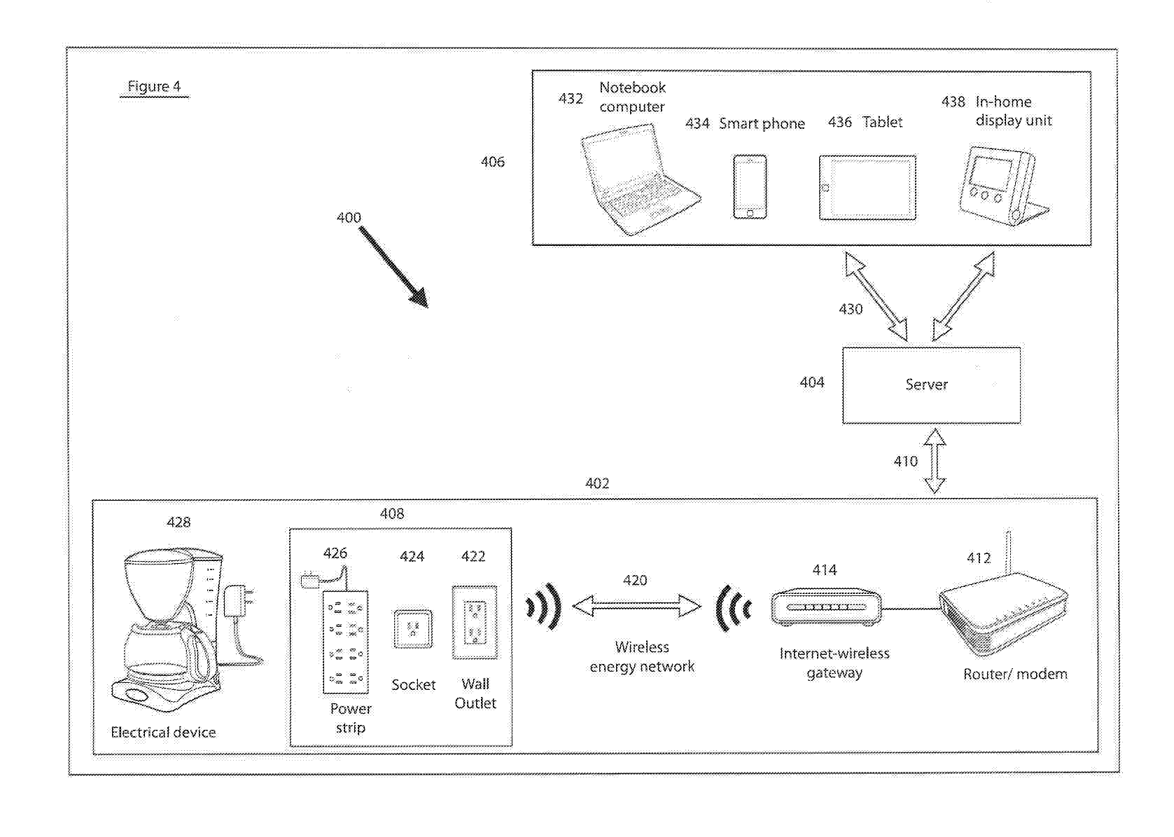

FIG. 4 is a schematic diagram of an energy management system in accordance with an embodiment of an aspect of the present invention;

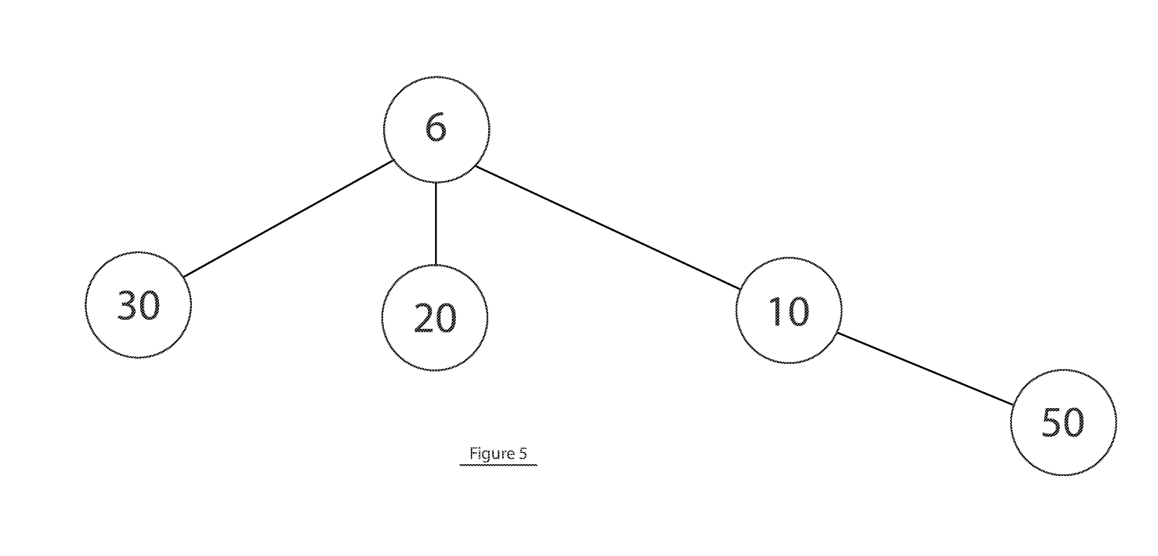

FIG. 5 is a schematic of a hierarchical decision tree for grouping power profiles in accordance with an embodiment of an aspect of the present invention;

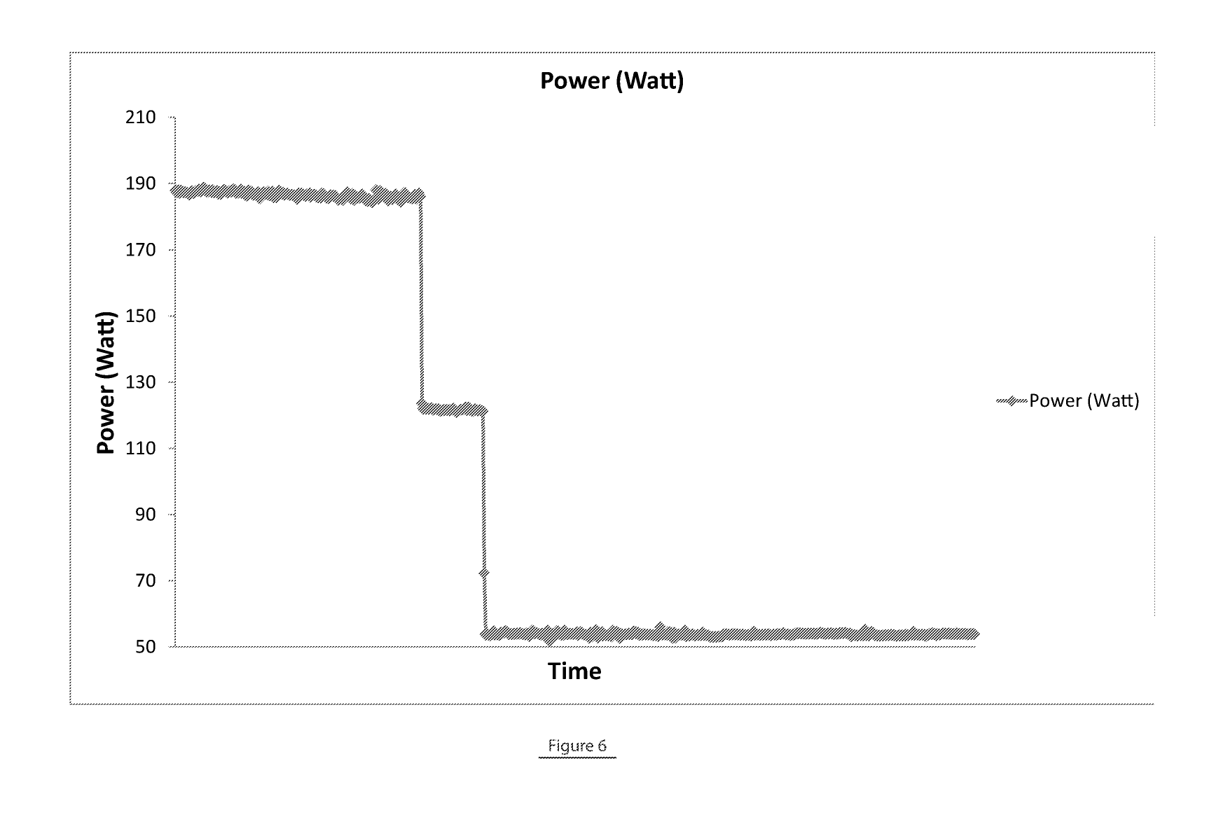

FIG. 6 is a power profile of an electrical device over a period of time; and

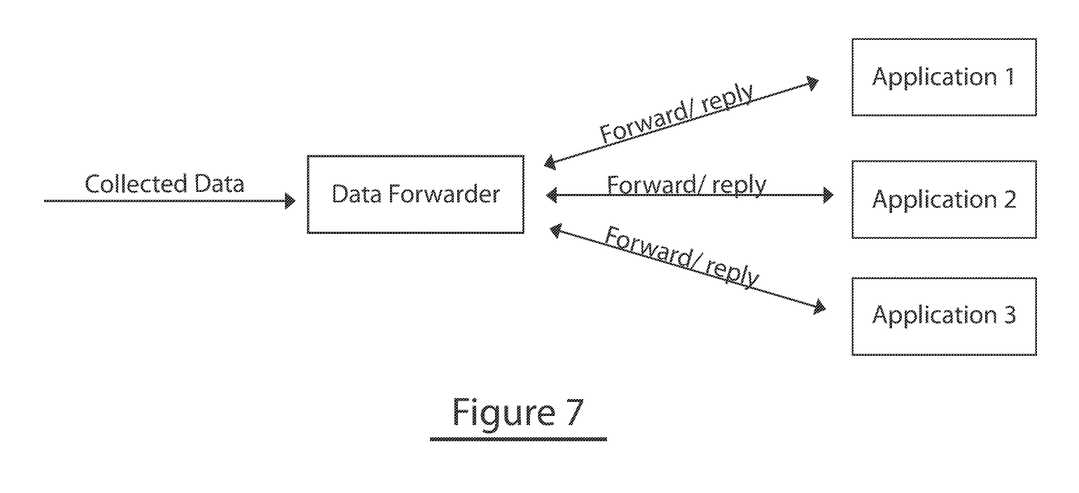

FIG. 7 is a flow diagram of the operation of a data forwarder of a hub in an energy management system in accordance with an embodiment of an aspect of the present invention.

### MODE FOR THE INVENTION

### Mode for Invention

Referring to the figures, an energy management system 400 in accordance with an embodiment of the present invention comprises a server 404, and one or more network devices 406 and 408 communicatively connectable to the server. At least one of the network devices is a power measurement device 408 for connection with an electrical device 428 to collect real-time power data from the electrical device. The server 404 compares the real-time power data with a corresponding power profile of the electrical device 428 to determine whether preset trigger criteria has been met, and initiates a predetermined action when the preset trigger criteria has been met.

The term ‘power’ can mean any parameter of the power consumed by an electrical device. The term ‘power profile’ can mean the value, behavior, variation, pattern, trend, or the like, over time (or any time or frequency domain) of any parameter of the power consumed by an electrical device. Parameters that can be measured include the voltage, current, power (watts), active power, reactive power, current harmonics, and combinations thereof. As such the ‘power profile’ can be used to identify or categorize an electrical device.

The power measurement device 408 can take many forms. For example, the power measurement device can comprises a power socket 424, where the electrical device 428 can be plugged into the power socket. The power measurement device 408 can comprise a power strip 426 having a plurality of power sockets, where one or more of the electrical devices 428 can each be plugged into a respective one of the power sockets. The power measurement device 408 can also comprise a wall outlet 422 having one or more power sockets, where one or more of the electrical devices 428 can each be plugged into a respective one of the power sockets. The power measurement device 408 can also comprise a power measurement module embedded in the electrical device. Such a power measurement module can be used in a situation where a manufacturer of an electrical device, such as a television, refrigerator, or air conditioner, embeds the power measurement module in the electrical device before sale to a consumer. For example, the power measurement module can be circuitry, a circuit board integrated with other circuitry in the electrical device, or a modular circuit board. The consumer can then use the electrical device within an energy management system 400.

Typical embodiments of the energy management system 400 comprise a plurality of the power measurement devices 408 for collecting real-time power data from one or more of the electrical devices 428. These electrical devices can be any type of electrical device such as televisions, computers, audio-visual equipment, refrigerators, microwaves, ovens, kitchen appliances, air conditioners, and other home or business appliances.

At least one of the network devices is a personal device 406. The personal device 406 can take the form of a notebook computer 432, a mobile device, a smart phone 434, a tablet or pad computer 436, an in-home display unit 438, or any other input and/or display device for use by users. A user can set the preset trigger criteria from the personal device. A user can also set the predetermined action from the personal device.

The server 404 communicates with the one or more network devices 406 and 408 using one or both of a wireless communication protocol and a powerline communication protocol. For example, as shown in FIG. 4, the server 404 connects via a network 410 to a router/modem 412 and an internet-wireless gateway 414 on the same site 402 as the power measurement devices 408 and electrical devices 428. The router/modem 412 and the internet-wireless gateway 414 can communicate wirelessly with the power measurement devices 408 over a wireless network 420. The wireless network can be, for example, a Wi-Fi network. The server 404 can be on the same site as the power measurement devices 408, or it can be off-site at some other location. The server can be hosted by a vendor providing services to the owner of the site 402. The network 410 over which the server connects with the on-site router/modem 412 and internet-wireless gateway 414 can be a wired network, or a wireless network, using protocols such as 3G, 4G, EDGE, cellular, or WiMAX. The scale of the network can be LAN or WAN and can be any of the known protocols for LAN or WAN. The personal devices 406 can also connect with the server 404 over a wired network, or a wireless network, using protocols such as 3G, 4G, EDGE, cellular, or WiMAX. The scale of the network can be LAN or WAN and can be any of the known protocols for LAN or WAN.

It is therefore appreciated by those skilled in the art that the energy management system 400 can be termed a remote energy management system when the system is being operated from an off-site (i.e. remote) location.

In one embodiment, the server 404 generates the corresponding power profile from the real-time power data. The server 404 can generate the corresponding power profile from the real-time power data upon an instruction issued from a user through one of the network devices 406 and 408. The server 404 can additionally or alternatively generate the corresponding power profile from the real-time power data automatically at one or more predetermined setpoints. For example, a predetermined setpoint is upon connection of the electrical device 428 to the power measurement device 408. In other words, as soon as an electrical device 428 is connected, or reconnected, to a power measurement device 408, the server 404 generates the corresponding power profile from the real-time power data.

The corresponding power profile can comprise, including taking the form of, a power signature. The server 404 generates the power signature by analyzing the real-time power data to detect a duty cycle of the electrical device 428. The duty cycle has one or more power levels. The power signature is defined by the power levels of the duty cycle. FIG. 6 shows a power profile of an electrical device. In this case, the power profile is the power value over one day. The power levels of the duty cycle can be identified by the three different horizontal lines on the graph, each of which correspond to three different power levels respectively, namely 190, 120, and 50. These three power levels define the power signature. It is noted that the duration of these power levels are not taken into account. In other embodiments, the power signature can be formulated in other ways and can be based on parameters other than the power levels of a duty cycle. In general, a power signature characterizes a power profile of an electrical device.

The corresponding power profile generated by the server 404 is stored on a database for future use as a preloaded power profile. The database can be part of the server 404, separate to the server 404 but at the same location, or even at a completely different location. The database can be hosted by a vendor who provides services to the owner of the site 402, and if the server is also vendor-hosted, this vendor can be different to or the same as the vendor who hosts the server 404.

In another embodiment, one or more preloaded power profiles are pre-stored on a database. The server 404 compares the real-time power data with the one or more preloaded power profiles and allocates one of the preloaded power profiles as the corresponding power profile of the electrical device 428. A matching algorithm can be used to select the preloaded power profile to be allocated. In some embodiments, a user can verify that the preloaded power profile allocated by the server is correct.

In a further embodiment, a user allocates one of the preloaded power profiles as the corresponding power profile of the electrical device.

In other embodiments, the system is capable of combining two or more of the above embodiments where the server 404 generates the corresponding power profile from the real-time power data, the server 404 allocates one of the preloaded power profiles as the corresponding power profile, or a user allocates one of the preloaded power profiles.

Similar to that described above in respect of the corresponding power profile, the preloaded power profiles can each comprise, including taking the form of, a power signature defined by one or more power levels corresponding to a duty cycle of an electrical device. The preloaded power profiles can be grouped in a hierarchical decision tree based on the power levels of the respective power signatures. FIG. 5 shows such a decision tree. The values in the nodes represent the different power levels that define different power signatures. In the decision tree shown in FIG. 5, the three different power signatures represented are: [6, 30]; [6, 20]; and [6, 10, 50]. The preset trigger criteria, for example, can be the electrical device achieving a predetermined one of the power levels. In this case, the predetermined one of the power levels, say, the power level of 6 in the specific example above, can be analysed as a standby power level, and therefore the preset trigger criteria is met when the electrical device exhibits this power level. As another example, the preset trigger criteria can be changes of a certain amount to the power levels. These changes to the power levels can be indicative of the health of an electrical device, including when the health is deteriorating.

Particular predetermined actions can therefore apply to all electrical devices having the same power signature, or to electrical devices having similar power signatures, that is, power signatures with a certain number of power levels that are the same. In other embodiments, this may not be the case. For example, the power profile can also include an identifier for the electrical device or type of electrical device. Particular predetermined actions can apply electrical devices with a certain power signature combined with a certain identifier, and therefore, different predetermined actions can apply to electrical devices with the same power signature but with different identifiers.

The predetermined action can be sending an alert to one or more of the network devices 406 and 408. The predetermined action can be turning off the electrical device. For example, referring to the example above, when the electrical device exhibits a power level that has been analysed as a standby power level, the preset trigger criteria is met, which triggers the predetermined action of turning off the electrical device. The predetermined action can also be providing recommendations to a user. For example, the power profile can show how an electrical device is being used, including when the electrical device such as a computer is running idle. The predetermined action can be recommendations on how the user can change their usage behavior in respect of the electrical device in order to save on energy consumption. The power profile can also show the cost of energy consumption based on when the electrical device is being used during a day. The predetermined action can be recommendations on how the user can change their usage behavior in respect of the electrical device in order to save on energy consumption costs.

An embodiment of another aspect of the present invention provides an energy management system comprising a server 404, and one or more network devices 406 and 408 communicatively connectable to the server. At least one of the network devices is a power measurement device 408 for connection with an electrical device 428 to collect real-time power data from the electrical device. The server 404 allocates a corresponding power profile to the electrical device 428.

Other embodiments of this aspect of the present invention are evident from the description above. For example, other embodiments include the different methods the server can allocate a corresponding power profile as described above, including where the server 404 generates the corresponding power profile from the real-time power data, the server 404 allocates one of the preloaded power profiles as the corresponding power profile, a user allocates one of the preloaded power profiles, or any combination of these methods.

In one embodiment, the server 404 generates the corresponding power profile from the real-time power data. The server 404 can generate the corresponding power profile from the real-time power data upon an instruction issued from a user through one of the network devices 406 and 408. The server 404 can additionally or alternatively generate the corresponding power profile from the real-time power data automatically at one or more predetermined setpoints. For example, a predetermined setpoint is upon connection of the electrical device 428 to the power measurement device 408. In other words, as soon as an electrical device 428 is connected, or reconnected, to a power measurement device 408, the server 404 generates the corresponding power profile from the real-time power data.

The corresponding power profile can comprise, including taking the form of, a power signature. The server 404 generates the power signature by analyzing the real-time power data to detect a duty cycle of the electrical device 428. The duty cycle has one or more power levels. The power signature is defined by the power levels of the duty cycle. The description of FIG. 6 above describes this in further detail. In other embodiments, the power signature can be formulated in other ways and can be based on parameters other than the power levels of a duty cycle. In general, a power signature characterizes a power profile of an electrical device.

The corresponding power profile generated by the server 404 is stored on a database for future use as a preloaded power profile. The database can be part of the server 404, separate to the server 404 but at the same location, or even at a completely different location. The database can be hosted by a vendor who provides services to the owner of the site 402, and if the server is also vendor-hosted, this vendor can be different to or the same as the vendor who hosts the server 404.

In another embodiment, one or more preloaded power profiles are pre-stored on a database. The server 404 compares the real-time power data with the one or more preloaded power profiles and allocates one of the preloaded power profiles as the corresponding power profile of the electrical device 428. A matching algorithm can be used to select the preloaded power profile to be allocated. In some embodiments, a user can verify that the preloaded power profile allocated by the server is correct.

In a further embodiment, a user allocates one of the preloaded power profiles as the corresponding power profile of the electrical device.

Similar to that described above in respect of the corresponding power profile, the preloaded power profiles can each comprise, including taking the form of, a power signature defined by one or more power levels corresponding to a duty cycle of an electrical device. The preloaded power profiles can be grouped in a hierarchical decision tree based on the power levels of the respective power signatures. The description of FIG. 5 above provides more detail of such a decision tree.

An embodiment of another aspect of the present invention provides a method of managing energy with an energy management system comprising a server 404, and one or more network devices 406 and 408 communicatively connectable to the server. At least one of the network devices is a power measurement device 408 for connection with an electrical device 428 to collect real-time power data from the electrical device. The method comprises: comparing the real-time power data with a corresponding power profile of the electrical device to determine whether preset trigger criteria has been met; and initiating a predetermined action when the preset trigger criteria has been met.

Further embodiments of the method are evident from the foregoing description.

In one further embodiment, at least one of the network devices is a personal device 406, and the method comprises allowing a user to set the preset trigger criteria from the personal device. Additionally or alternatively, the method comprises allowing a user to set the predetermined action from the personal device.

In one embodiment, the method comprises generating the corresponding power profile from the real-time power data. The method comprises generating a power signature as part of the corresponding power profile by: analyzing the real-time power data to detect a duty cycle of the electrical device, the duty cycle having one or more power levels; and defining the power signature with the power levels of the duty cycle. In other embodiments, the power signature can be formulated in other ways and can be based on parameters other than the power levels of a duty cycle. In general, a power signature characterizes a power profile of an electrical device.

Turning back to the present embodiment, the method comprises storing the corresponding power profile on a database for future use as a preloaded power profile. The method comprises: storing a plurality of corresponding power profiles each corresponding to a respective electrical device; and grouping the plurality of corresponding power profiles in a hierarchical decision tree based on the power levels of the respective power signatures.

In another embodiment, the method comprises: comparing the real-time power data with one or more preloaded power profiles pre-stored on a database; and allocating one of the preloaded power profiles as the corresponding power profile of the electrical device.

An embodiment of yet another aspect of the present inventions provides a method of managing energy with an energy management system comprising a server 404, and one or more network devices communicatively connectable to the server. At least one of the network devices 406 and 408 is a power measurement device 408 for connection with an electrical device to collect real-time power data from the electrical device. The method comprises: allocating a corresponding power profile to the electrical device.

Further embodiments of the method are evident from the foregoing description.

In one further embodiment, the method comprises generating the corresponding power profile from the real-time power data. The method comprises generating a power signature as part of the corresponding power profile by: analyzing the real-time power data to detect a duty cycle of the electrical device, the duty cycle having one or more power levels; and defining the power signature with the power levels of the duty cycle. In other embodiments, the power signature can be formulated in other ways and can be based on parameters other than the power levels of a duty cycle. In general, a power signature characterizes a power profile of an electrical device.

Turning back to the present embodiment, the method comprises storing the corresponding power profile on a database for future use as a preloaded power profile. The method also comprises: storing a plurality of corresponding power profiles each corresponding to a respective electrical device; and grouping the plurality of corresponding power profiles in a hierarchical decision tree based on the power levels of the respective power signatures.

In another embodiment, the method comprises: comparing the real-time power data with one or more preloaded power profiles pre-stored on a database; and allocating one of the preloaded power profiles as the corresponding power profile of the electrical device.

An embodiment of another aspect of the present invention provides a non-transitory computer-readable storage medium with an executable program stored thereon, wherein the program instructs a server to perform the method according to any of the embodiments described above.

The figures will now be described in more detail, including specific implementation details, in order to describe further specific embodiments of the present invention.

FIG. 1 illustrates a method of detecting and analyzing device power profiles. The method consists of combinations of data measurement, user input, and software analysis. Portions or all of the method of FIG. 1 can be used with portions or all of the energy management systems, devices, or apparatuses disclosed herein, or any other type of system, controller, device, module, processor, or any combination thereof, operable to employ all, or portions of the method of FIG. 1. Additionally, the method can be embodied in various types of encoded logic including software, firmware, hardware, or other forms of digital storage mediums, computer readable mediums, or logic, or any combination thereof, operable to provide all, or portions, of the method of FIG. 1.

The method begins generally at block 100. At block 102, the power measurement devices 408 form a network for power data collection. The network can be comprised of various types of sub-networks such as Zigbee, Z-Wave, Bluetooth and Wi-Fi and powerline communication. The power measurement devices 408 in the network can include power sockets 424, power strips 426, and presence sensors. There can be one special device, namely a hub, in the network which initiates the network construction and acts as a gateway between the power measurement devices 408 and the internet for internet-connected embodiments. The hub accepts new power measurement devices 408 to the network, collects the data from power measurement devices 408, performs some simple processing and transmits the data to the server 404 on the internet.

According to one embodiment, at block 104, after a power measurement device 408 is accepted to the network and starts to collect data, the hub will assign a time slot to that device so that it will transmit its data in that time slot. The time slots are assigned to different power measurement devices 408 in such a way that the data transmissions from different devices will unlikely to happen within the same time slot. This is done to minimize chances for data collision. Since there can be different types of power measurement devices 408 collecting data of different type in the network, a universal packet format for different types of devices in the network is used. One example of such a packet is as follows:

TABLE 1

| | | | | |
|---|---|---|---|---|
| Network type | Packet header | Packet payload | Header | Payload |
| | length | length | | |

‘Network type’ indicates the type of sub-network being used. Examples include Bluetooth, Zigbee and powerline. ‘Packet header’ contains the control information about the packets. For certain networks such as Bluetooth or Zigbee, it is important to include the sender or the receiver information in the packets so that the system can know where the data is coming from. Since different types of network may have different data lengths for control information, we have included a field called ‘packet header length’. ‘Payload’ contains the real data collected from the power measurement device 408. Similarly, different devices may collect different amount of data so we also have the field ‘packet payload length’ to indicate the payload length.

According to further embodiments, device data can be provided in various forms and types of information. For example, device data can include a device identifier, a network identifier, measurement data, various other types of data that can be used to manage energy use, or any combination thereof. In some embodiments, device data can be formatted based on a wireless communication protocol (e.g. Zigbee, WIFI, Bluetooth etc.) being used in the system.

According to one embodiment, after the hub receives data from the devices, the data is processed at step 106. As shown in the FIG. 7, the hub internally has a data forwarder which forwards the data collected from the power measurement devices 408 to different applications over the network. It also relays the data from different applications to the devices in the network.

This allows different applications to receive and process different types of messages without stepping on or conflicting with each other. For instance, a Bluetooth application will filter out the messages if they are from Bluetooth sub-networks. By combining the data forwarder with the packet format, more types of devices can be easily added to the energy management system 400.

The method now proceeds to block 108. According to an embodiment, the hub initiates data transfer of the network devices to the server 404. The data is uploaded to the server with an XML format which can be directly mapped to a backend database. The XML file is divided into sections where each section represents an update, insert or delete operation to the database. Inside each section, each XML tag name directly corresponds to a table name or a column name in the database. Furthermore, each XML attribute is used to find the relevant record for updating. For instance, if we want to create a new data entry for a socket, with power, voltage and current values equal to 220, 110 and 2 respectively, then the XML should roughly look like following:

<socket id=‘1’>
<power>220</power>
<voltage>110</110>
<current>2</current>
</socket>

All data uploaded to the server 404 can be encrypted with SSL.

According to one embodiment, at decision block 110, upon completion of data transfer for a duration set by the system, the method can proceed to decision block 112. If the data acquisition is not yet completed, the system continues to acquire data from the electrical device. According to one embodiment, at block 112, data grouping is carried out (see FIG. 3). For example, the device power data can be grouped using DBSCAN, OPTICS or other data clustering techniques. The power data clusters can also be classified into standby power cluster, operating power clusters. If at decision block 112, the data collected is tested to be invalid, the user can proceed to block 114. According to one embodiment, the user-initiated or manual measurement process is initiated, when the device is put into specific state and the user triggers the system to start the measurement process. For example, the user can put the device into standby state and record the standby power consumption level. The user can also put the device into operating power states and record the operating power consumption levels.

According to another embodiment, upon completion of power data collection, the method can proceed to block 116. According to a further embodiment, the power profile of the electrical device 428 can be generated and stored. For example, the data can be stored as values: average operating power and standby power. The data can also be used to create device classification information.

FIG. 2 illustrates a method of managing energy at a site according to an embodiment of an aspect of the present invention. The method consists of combinations of data measurement, user input, and software analysis. Portions or all of the method of FIG. 2 can be used with portions or all of the energy management systems, devices, or apparatuses disclosed herein, or any other type of system, controller, device, module, processor, or any combination thereof, operable to employ all, or portions of the method of FIG. 2. Additionally, the method can be embodied in various types of encoded logic including software, firmware, hardware, or other forms of digital storage mediums, computer readable mediums, or logic, or any combination thereof, operable to provide all, or portions, of the method of FIG. 2.

The method begins generally at block 200. At block 202, the power measurement device network is established. The network, for example, can include various types of networks configured to communicate information to manage energy use of electrical devices accessible to the network. For example, a network can include one or more of any combination or portion of, Zigbee communication, Z-Wave communication, Bluetooth communication, Wi-Fi communication, various proprietary wireless communications, powerline communication or any combination thereof.

According to one embodiment, at block 204, network device data can be measured. For example, device data can be obtained by sending a request to one or more network devices joined to a network. Multiple devices can also be accessed at an acquisition interval to obtain device data. According to a further embodiment, device data can be provided in various forms and types of information. For example, device data can include a device identifier, a network identifier, measurement data, various other types of data that can be used to manage energy use, or any combination thereof. According to a further embodiment, device data can be formatted based on a wireless communication protocol (e.g. Zigbee, WIFI, Bluetooth etc.) being used by the system 400.

According to an embodiment, upon acquiring device data from one or more network devices, the device data can be translated at step 206. In one embodiment, device data can be translated into another format to use by another system, process, device, etc. other than the system 400. For example, proprietary communications formatted data can be translated into XML, JSON encoded data. The method can now proceed to block 208. According to an embodiment, a controller initiates data transfer of the network devices to the server. For example, the controller can be a home internet gateway using a wireless communication protocol to form a network with wireless network devices. The data can also be translated into XML and then be uploaded to a server using SSL or other encryption methods via the internet. According to a further embodiment, at block 208, real-time data is transferred to a server.

The method can now proceed to block 210. According to an embodiment, the server 404 can initiate analysis to detect device real-time state with reference to a stored power profile 212 of an electrical device. At block 216, for example, a user can run an application program on mobile devices or computer to communicate with the server by using a Wi-Fi network, 3G data network, 4G data network, or other subscriber based wireless information network.

According to a further embodiment, mobile device, computer, or any other personal device 406 can set the trigger criteria of an electrical device. For example, the trigger criteria can be defined as satisfied when the device is in standby power state. At block 214, device real-time state is compared with user-defined trigger criteria. At decision block 218, if the criteria are met, then the method can proceed to block 220. At block 222, a user can run an application program on mobile devices or computer to communicate with the server by using a Wi-Fi network, 3G data network, 4G data network, or other subscriber based wireless information network. The mobile device 406 can then communicate the defined actions to the server 404. The method can proceed to block 216. According to an embodiment, the server 404 initiates actions as specified by the user. For example, the user can define the action as sending push notifications to his or her mobile devices. The network device can also receive a control message from the server, a control action can be extracted from the incoming message and the operating condition at the network device can be altered using the control action data. For example, a clothes washer or dryer may be turned off, or various other types of control actions can be initiated based on the criteria set by the user.

FIG. 3 illustrates a grouping method according to an embodiment of another aspect of the present invention. The method begins generally at block 300. At block 302, the data is fetched from the server database. According to an embodiment, the duty cycle of the device is measured. Duty cycle is a period during which the device is continuously using power and starts and ends with an ‘off’ state. At decision block 306, if no duty cycle is detected, the entire measurement period is used for processing as shown at block 308. This is a best-effort approach when one or more distinct duty cycles can be measured. If at decision block 306, at least one duty cycle is detected, the method can proceed to block 310. The duration covering these cycles is used for power profile processing at block 312. According to one embodiment, the electrical device power data can be grouped using DBSCAN, OPTICS or other data clustering techniques. The power data clusters can also be classified into standby power cluster, operating power clusters and stored in a server database.

According to a further embodiment, the duty cycle data can be used to identify the electrical devices. Each electrical device can also be categorized according to its power signature. Each signature is defined as a sequence of distinct power values corresponding to a duty cycle. For example, the power value profile of an electrical device over a one-day time period is shown in FIG. 6.

There are three distinct values [190, 120, 50] during this period of time so the power signature of the electrical device for the day will also have three values. Here we do not take the time duration for each power value into consideration when defining a power signature of the electrical device. This is because the duration of a particular power value can be dependent on the usage by a user. For example, a television may be turned on for different hours during different days. This can lead to slightly different duty cycles but the same television will still have the same power signature. Mathematically, the device signature can be represented as a vector where each element corresponds to a power value. In the example above, the vector for representing the power signature of the described electrical device is [190, 120, 50]. By calculating the distance between different vectors, the similarity between different electrical devices can be computed. This approach is used to design an algorithm for classifying the electrical devices. The algorithm is based on a decision tree where each tree node represents an element in the power signature vector. For instance, three power signatures: [6, 30], [6, 20], [6, 10, 50] can result in a hierarchical decision tree as shown in FIG. 5.

After the tree is created, it can be used to categorize new electrical devices 428. If the system detects a new electrical device 428 with a power signature vector of [6, 10, 48], then the new device is probably the same type of device as the right most branch in the decision tree shown in FIG. 5.

FIG. 4 illustrates an energy management system according to an embodiment of the present invention. The energy management system 400 is configured to be used at a site 402. Site 402 can be a residential site, an industrial site, a manufacturing site, a commercial site, or any combination thereof. According to an embodiment, the energy management system 400 includes a server 404 located at a remote location that can be communicatively coupled to a network 410. According to a further embodiment, the site 402 includes a radio-frequency gateway 414 connecting to wireless sockets 424. In one form, RF gateway 414 establishes a wireless network 420 using any suitable wireless communication protocol, including those described herein. Various combinations of networks and variants thereof can also be deployed by RF gateway 414 to establish wireless network 420.

According to a further embodiment, mobile devices, computer devices, notebook computers 432, smart phones 434, tablet computers 436, and other personal devices 406, communicate with an information network 430 using a subscriber based wireless data communication network such as a 3G network, 4G network, EDGE network, a cellular network, WiMAX, other wireless data communication, or any combination thereof. According to a further embodiment, the site 402 includes a broadband modem/router 412 which provides internet access to the RF gateway 414.

According to a further embodiment, the energy management system 400 includes a server 404 configurable to include various energy management logic, modules, interfaces, database sources, or various combinations thereof to manage energy use at the site 400. According to an embodiment, the server 404 can be located in a single location. However, multiple locations, and server configurations including cloud computing, distributed computing, dedicated computing, or any combination thereof can be deployed.

According to a further embodiment, the energy management system 400 is used with an energy management application accessible or deployed by mobile devices, computer devices, or other personal devices 406. For example, the energy management application can be used to control the power measurement devices 408. A user can access the energy management application using mobile devices, computer devices, or other personal devices 406 and read the current settings, operating conditions, or various other types of energy management information associated with the electrical devices 428 connected to the power measurement devices 408. For example, a user can view if an electrical device 428 is on or off, or any of its other power parameters. In other forms, the user can use the energy management application to access network devices at site 402. Although the energy management application has been described with the specific examples above, it is to be understood that other network devices, smart appliances, lighting systems, or any other energy consuming or network accessible device or any combination thereof can be accessed using the energy management application.

According to an embodiment, a wireless device network 420 is established. The network, for example, can include various types of wireless networks configured to communicate information to manage energy use of electrical devices connected to the network via the power measurement devices 408. For example, a network can include one or more of any combination or portion of, Zigbee communication, Z-Wave communication, Bluetooth communication, Wi-Fi communication, various proprietary wireless communications, powerline communication or any combination thereof.

According to a further embodiment, the power measurement devices 408 measure the power parameters of electrical device 428. Data collected by the power measurement devices 408 can be obtained via the RF gateway 414 by sending a request to one or more network devices joined to a network. For example, multiple devices can be accessed at an acquisition interval to obtain device data. Electrical device data can be provided in various forms and types of information. According to one embodiment, electrical device data can include a device identifier, a network identifier, measurement data, or various other types of data that can be used to manage energy use, or any combination thereof. In another form, device data can be formatted based on a wireless communication protocol (e.g. Zigbee, WIFI, Bluetooth etc.) being used by the system.

According to an embodiment, upon acquiring power data from one or more electrical devices, the data can be translated into another format for use by another system, process, device, etc. other than the energy management system 400. For example, proprietary communications formatted data can be translated into XML, JSON encoded data. The RF gateway 414 initiates data transfer of the network devices. For example, a home internet gateway using a wireless communication protocol can be used to form a network with wireless network devices. For example, the data can be translated into XML and then be uploaded to a server using SSL or other encryption methods via the internet.

According to a further embodiment, real-time data is transferred to a server 404. A user can run an application program on mobile devices, computer devices, or other personal devices 406 to communicate with the server by using a Wi-Fi network, 3G data network, 4G data network, or other subscriber based wireless information network. The personal devices 406 can then set the trigger criteria of an electrical device. The trigger criteria, for example, can be defined as satisfied when the device is in a standby power state. The server 404 compares real-time data with preloaded power profiles to identify the real-time state of the electrical device. A user can run an application program on personal devices 406 to communicate with the server 404 by using a Wi-Fi network, 3G data network, 4G data network, or other subscriber based wireless information network. The personal device 406 can then communicate the defined actions to the server 404. The server 404 initiates the actions as specified by the user. For example, the user can define the action as sending push notifications to his or her personal devices, or the network device can receive the control message from the server, a control action can be extracted from the incoming message and the operating condition at the network device can be altered using the control action data. For example, a clothes washer or dryer can be turned off, or various other types of control actions can be initiated based on the criteria set by the user.

With embodiments of the energy management systems of the present invention, the power parameters and energy usage data obtained from electrical devices can be conveniently used to allow the energy management system to respond to changes in the power profile of electrical devices with minimum user input. Embodiments of the present invention also provide software application programs that instruct servers and other computers to automatically perform predetermined actions based on real-time power data and predetermined trigger criteria set by a user. In particular, embodiments of the present invention address the need to minimize complicated user interventions by responding to changes in the power profiles, parameters, and conditions of electrical devices by initiating predetermined actions automatically.

It can be appreciated that the aforesaid embodiments are only exemplary embodiments adopted to describe the principles of the present invention, and the present invention is not merely limited thereto. Various variants and modifications may be made by those of ordinary skill in the art without departing from the spirit and essence of the present invention, and these variants and modifications are also covered within the scope of the present invention. Accordingly, although the invention has been described with reference to specific examples, it can be appreciated by those skilled in the art that the invention can be embodied in many other forms. It can also be appreciated by those skilled in the art that the features of the various examples described can be combined in other combinations. In particular, there are many possible permutations of the circuit arrangements described above which use the same passive method to achieve passive power factor correction, and which will be obvious to those skilled in the art.

1-34. (canceled)

35. An energy management system comprising:
a server; and
one or more network devices communicatively connectable to the server, at least
one of the network devices being a power measurement device for connection with an
electrical device to collect real-time power data from the electrical device;
the server comparing the real-time power data with a corresponding power profile
of the electrical device to determine whether preset trigger criteria has been met, and
initiating a predetermined action when the preset trigger criteria has been met.

36. An energy management system according to claim 35 wherein the power measurement device comprises a power socket, the electrical device being plugged into the power socket.

37. An energy management system according to claim 35 wherein the power measurement device comprises a power measurement module embedded in the electrical device.

38. An energy management system according to claim 35 wherein at least one of the network devices is a personal device, and a user sets the preset trigger criteria from the personal device.

39. An energy management system according to claim 38 wherein a user sets the predetermined action from the personal device.

40. An energy management system according to claim 35 wherein the server generates the corresponding power profile from the real-time power data.

41. An energy management system according to claim 40 wherein the server generates the corresponding power profile from the real-time power data upon an instruction issued from a user through one of the network devices.

42. An energy management system according to claim 40 wherein the server generates the corresponding power profile from the real-time power data automatically at one or more predetermined setpoints.

43. An energy management system according to claim 42 wherein one of the predetermined setpoints is upon connection of the electrical device to the power measurement device.

44. An energy management system according to claim 40 wherein the corresponding power profile comprises a power signature, and wherein the server generates the power signature by analyzing the real-time power data to detect a duty cycle of the electrical device, the duty cycle having one or more power levels and the power signature being defined by the power levels of the duty cycle.

45. An energy management system according to claim 35 wherein one or more preloaded power profiles are pre-stored on a database.

46. An energy management system according to claim 45 wherein the server compares the real-time power data with the one or more preloaded power profiles and allocates one of the preloaded power profiles as the corresponding power profile of the electrical device.

47. An energy management system according to claim 45 wherein a user allocates one of the preloaded power profiles as the corresponding power profile of the electrical device.

48. An energy management system according to claim 45 wherein the preloaded power profiles each comprise a power signature defined by one or more power levels corresponding to a duty cycle of an electrical device, and the preloaded power profiles are grouped in a hierarchical decision tree based on the power levels of the respective power signatures.

49. An energy management system according to claim 35 wherein the predetermined action is sending an alert to one or more of the network devices.

50. An energy management system according to claim 35 wherein the predetermined action is or includes turning off the electrical device.

51. A method of managing energy with an energy management system comprising:
a server; and
one or more network devices communicatively connectable to the server, at least
one of the network devices being a power measurement device for connection with an
electrical device to collect real-time power data from the electrical device;
the method comprising:
comparing the real-time power data with a corresponding power profile of the electrical device to determine whether preset trigger criteria has been met; and
initiating a predetermined action when the preset trigger criteria has been met.

52. A method according to claim 51 comprising generating the corresponding power profile from the real-time power data.

53. A method according to claim 51 comprising:
comparing the real-time power data with one or more preloaded power profiles
pre-stored on a database; and
allocating one of the preloaded power profiles as the corresponding power profile of the electrical device.

54. A non-transitory computer-readable storage medium with an executable program stored thereon, wherein the program instructs a server to perform the method according to claim 51.
